(19) United States
(12) Patent Application Publication
(10) Pub. No.: US 2009/0271447 A1
(43) Pub. Date: Oct. 29, 2009

(54) METHOD FOR SYNCHRONIZING CONTENTS FILE AND DEVICE FOR EMPLOYING THE SAME

(76) Inventors: Kang Soo SHIN, Soul (KR); Jae Young Chang, Seoul (KR); Sun Ryang Kim, Seoul (KR); Duk Ho Choi, Seoul (KR)

Correspondence Address: BIRCH STEWART KOLASCH & BIRCH, PO BOX 747, FALLS CHURCH, VA, 22040-0747, US

(21) Appl. No.: 12/431,473

(22) Filed: Apr. 28, 2009

(30) Foreign Application Priority Data
Apr. 28, 2008 (KR) 10-2008-0039416

(51) Int. Cl. G06F 17/30

(52) U.S. Cl. 707/201; 707/E17.01

(57) ABSTRACT

A method and device for synchronizing a contents file are discussed. An embodiment is directed to a method for synchronizing data using a target device, the target device including a target contents file, the method comprising: receiving file information of a reference contents file from a reference device; comparing the file information of the reference contents file and file information of the target contents file to determine whether a contents file synchronization is needed; and synchronizing the target contents file using the reference contents file based on the comparison result.

### CROSS-REFERENCE TO RELATED APPLICATIONS

The present application claims priority under 35 U.S.C. 119(a) to Korean Patent Application No. 10-2008-0039416 filed on Apr. 28, 2008, which is hereby incorporated by reference in its entirety.

### BACKGROUND

Recently, a great variety of convenient functions are added on a portable terminal or mobile terminal such as a cellular phone, a personal digital assistant (PDA), and a portable multimedia player (PMP). The function of storing and updating various personal information and contents in the portable terminal is becoming more useful.

However, since the storage capacity in the portable terminal may be insufficient, there is a limitation in satisfying a demand based on the recent time conditions where large-capacity contents overflow. Due to the limited capacity of the portable terminal, in order to store other contents files, a user needs to erase picture or music files that are previously stored in the portable terminal or to backup them in another large capacity storage device such as a personal computer (PC) via a universal series bus (USB), any one of which may be inconvenient to the user.

Moreover, in a case of a binary file such as a picture or MP3 file, there is still no technology for automatic synchronization or backup. There exists inconvenience in storing the above binary files in a hard disk of a PC via a USB cable or in downloading them from the PC via the USB cable.

### SUMMARY

Embodiments of the present invention provide a method and a device for synchronizing a contents file between at least two electronic devices.

Embodiments of the present invention also provide a method and a device for synchronizing a file between electronic devices more easily by determining a file to be transmitted through file information of a contents file.

Embodiments of the present invention are directed to a method and device for performing contents file synchronization, which address the limitations and disadvantages associated with the related art.

In one embodiment, a method of synchronizing a contents file between a portable terminal and a target device includes: receiving file information of a target contents file from the target device; comparing file information of a reference contents file and file information of the target contents file to determine whether the contents files are identical or not; and transmitting a different contents file to the target device in order to update the target contents file.

In another embodiment, a portable terminal for synchronizing a contents file with a target device, includes: a receiving unit configured to receive file information of a target contents file from the target device; a memory unit configured to store a reference contents file; a control unit configured to compare file information of the reference contents file with the file information of the target contents file to determine whether the contents files are identical or not; and a transmitting unit configured to transmit a different contents file to the target device in order to update the target contents file.

In an embodiment, there is provided a method for synchronizing data using a target device, the target device including a target contents file, the method comprising: receiving file information of a reference contents file from a reference device; comparing the file information of the reference contents file and file information of the target contents file to determine whether a contents file synchronization is needed; and synchronizing the target contents file using the reference contents file based on the comparison result.

In an embodiment, there is provided a method for synchronizing data using a synchronization requesting device, the method comprising: determining, by the synchronization requesting device, file type information of a target contents file which is to be synchronized; selecting a synchronization method corresponding to the determined file type information; and selectively synchronizing the target contents file with a reference contents file according to the selected synchronization method.

In an embodiment, there is provided a target device for synchronizing data with a reference device, the target device comprising: a storage unit configured to store therein a target contents file; a communication unit configured to communicate with the reference device; and a controller configured to receive file information of a reference contents file from the reference device, through the communication unit; to compare the file information of the reference contents file and file information of the target contents file to determine whether a contents file synchronization is needed; and to synchronize the target contents file using the reference contents file based on the comparison result.

In an embodiment, there is provided a synchronization requesting device for synchronizing data with a reference device, the synchronization requesting device comprising: a storage unit configured to store therein a target contents file; a communication unit configured to communicate with the reference device; and a controller configured to determine file type information of the target contents file which is to be synchronized; to select a synchronization method corresponding to the determined file type information; and to selectively synchronize the target contents file with a reference contents file through the communication unit according to the selected synchronization method.

The details of one or more embodiments are set forth in the accompanying drawings and the description below. Other features will be apparent from the description and drawings, and from the claims.

### BRIEF DESCRIPTION OF THE DRAWINGS

FIG. 1A is a view illustrating contents file synchronization between a portable terminal and a target device according to an embodiment of the present invention.

FIG. 1B is a flowchart illustrating a method of synchronizing a contents file between a portable terminal and a target according to an embodiment of the present invention.

FIG. 2 is a block diagram illustrating a portable terminal and a target device according to an embodiment of the present invention.

FIG. 3 is a flowchart illustrating a contents file synchronization process when a contents file is changed in the portable terminal according to an embodiment of the present invention.

FIGS. 4 and 5 are views displaying an example of a picture or drawing file when a contents file is transmitted into a target device according to the embodiment of FIG. 3.

FIG. 6 is a flowchart illustrating a contents file synchronization process when a contents file is changed in a target device according to an embodiment of the present invention.

FIG. 7 is a flowchart illustrating a synchronization process using file information according to an embodiment of the present invention.

FIG. 8 is a view illustrating an algorithm that confirms file information of a contents file in a folder according to further an embodiment of the present invention.

FIG. 9 illustrates an example of an algorithm for detecting a file to be transmitted and transmitting a file according to an embodiment of the present invention.

FIG. 10 illustrates an example of an algorithm for determining the receiving of a file and the deleting of a file of a target device according to an embodiment of the present invention.

FIGS. 11 and 12 are examples of views illustrating a process and a process result when a picture in a mobile phone is transmitted to a target device according to an embodiment of the present invention.

### DETAILED DESCRIPTION OF THE EMBODIMENTS

Reference will now be made in detail to the embodiments of the present disclosure, examples of which are illustrated in the accompanying drawings.

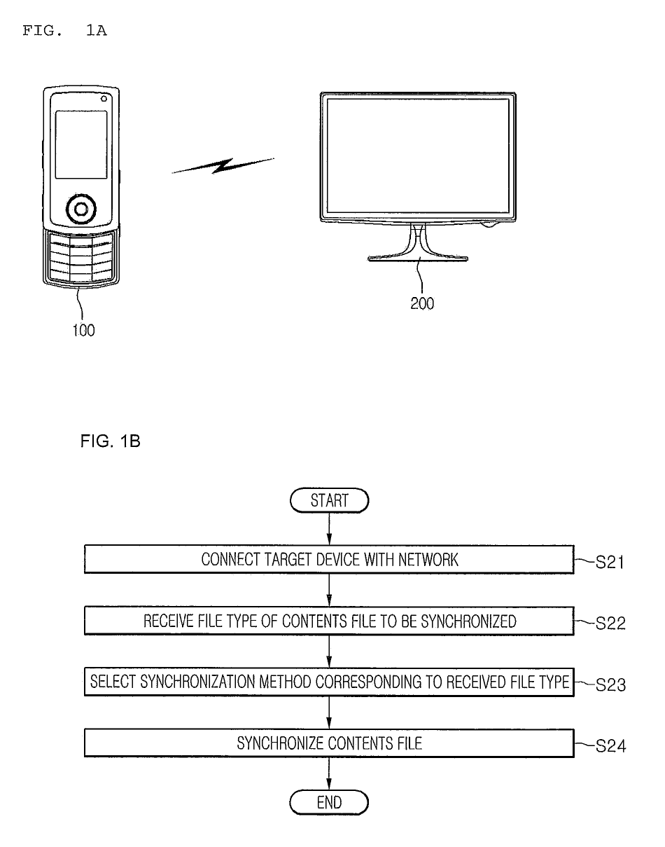

FIG. 1A is an example of a view illustrating contents file synchronization between a reference device 100 and a target device 200 according to an embodiment. A non-limiting example of the reference device 100 is a portable device, portable terminal or mobile terminal such as a mobile phone, smart phone, PDA, computer notebook, etc. A non-limiting example of the target device 200 is a non-mobile device such as a PC, desktop, workstation, kiosk, etc. In FIG. 1A, a mobile phone is shown as a mere example of the reference device 100 and a monitor/TV is shown as a mere example of the target device 200. However, clearly the invention is not limited thereto. For instance, the reference device 100 can be a non-mobile device and the target device 200 can be a mobile device. In fact, the reference device 100 and the target device 100 can be any two electronic devices capable of communicating with each other.

Hereinafter, a contents file described in the detailed description of the embodiments may be a binary file such as picture, image, MP3 files, etc. but is not limited thereto. For instance, the contents file may be a text file such as phone book, calendar, schedule, message files, etc.

Additionally, a target device (e.g., target device 200) is a device that has a contents file that needs to be updated/completed through data synchronization. Such contents file may be referred to as a target contents file. A reference device (e.g., reference device 100) is a device that already has an updated/completed contents file, which is then used to update the target contents file. The already updated/completed contents file in the reference device may be referred to as a reference contents file. Either the reference device or the target device can request a data synchronization, and the device that requests the data synchronization is referred to as a synchronization requesting device. Further, the steps of the methods discussed according to the embodiments of the present invention can be performed by the target device or the reference device.

In addition, the contents file may be a patch file for version up of an application program. In this case, for example, the portable device 100 (also referred to as the portable terminal) can compare version information of the application program installed in the portable device 100 with version information of an application program contained in a patch file stored in the target device 200. As a variation, this comparison may occur in the target device 200.

Then, if it is determined that the version of the application program installed in the portable device 100 is lower than that of the target device 200, the portable device 100 can receive the patch file stored in the target device 200 for updating its version. As a result, the portable device 100 (functioning as a target device) is updated via data synchronization using data from the target device 100 (functioning as a reference device in this example).

The application program installed in the portable device 100 may be a widget program displayed on a display of the portable device 100.

Hereinafter, according to an embodiment the portable device 100 is described as a device for performing synchronization, but the present invention is not limited thereto. That is, the portable device 100 can be any electronic device capable of storing a contents file and communicating the contents file with other devices.

According to the embodiment, the target device 200 may be a television, a personal computer, or a portable terminal, but is not limited thereto. That is, the target device 200 may be any electronic device capable of transmitting/receiving a contents file and storing the contents file.

The portable terminal 100 and the target device 200 transmit/receive a contents file each other through an arbitrary near field communication method.

In the present invention, Bluetooth technology among the near field communication methods can be used for easy understanding, but the present invention is not limited thereto. For example, all other near field communications such as Wibree, ultra low power (ULP), wireless fidelity (WIFI), Zigbee, and IrDA can be applied to the present invention.

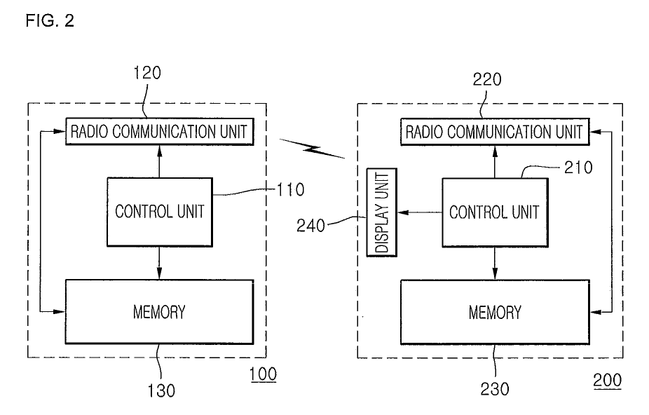

The portable terminal 100 and the target device 200 include respectively radio communication units 120 and 220 as shown in FIG. 2 for performing the near field communication or other communication operations. If the above two devices 100 and 200 exist within an area where a used near field communication method can detect, a synchronization process of a contents file can be performed between these devices according to the near field communication methods.

In order to perform the synchronization process, the target device 200 may be required to have a predetermined memory area. The memory area can be typically realized with a hard disk drive (HDD) or a solid state drive.

If a contents file is modified in the portable terminal 100 or the target device 200, the modified contents file is transmitted or received automatically, such that backup or download of the modified contents file can be performed without difficulties. The components of FIG. 2 will be discussed in more detail later.

FIG. 1B is a flowchart illustrating a method of synchronizing a contents file between the portable terminal 100 and the target device 200 according to an embodiment.

As illustrated in FIG. 1B, the contents file synchronization method includes operation S21 for connecting the target device 200 to a network (e.g., near field communication network or other network such as the Internet through which the target device 200 communicates with the reference device 100), operation S22 for receiving information about the file type of a contents file to be synchronized, operation S23 for selecting a synchronization method corresponding to the inputted file type, and operation S24 for synchronizing the contents file according to the selected synchronization method. According to an embodiment, the steps shown in FIG. 1B may be performed by a synchronization requesting device, which may be a reference device or a target device, e.g., device 100 or 200.

In order to perform synchronization, the portable terminal 100 is connected to the target device 200 via the network so as to be able to communicate with the target device 200 in operation S21. According to this embodiment, the network connection between the portable terminal 100 and the target device 100 is established through the above-mentioned near field communication, only as an example.

For example, if a user carrying the portable terminal 100 approaches the television (e.g., the target device 200), the network for data transmission via Bluetooth may be established between the portable terminal 100 and the target device 200.

According to the embodiment, the target device 200 may identify the specific portable terminal 100 that performs synchronization among a plurality of portable terminals in order to establish the network for synchronization.

For example, if the target device 200 is set to synchronize a contents file with the portable terminal 100 of only a specific user, there may be a plurality of portable terminals loaded with Bluetooth communication modules around the target device 200. In this case, according to the embodiment, the target device 200 identifies the specific portable terminal 100 that is predetermined for synchronization among the plurality of portable terminals, and then performs synchronization with the identified portable terminal 100.

For this end, according to the embodiment, the target device 200 can transmit an ID request message to the portable device 100 placed within the radio communication coverage of the target device 200. Then, the portable device 100 can transmit a signal (including identification information such as a serial number or identification (ID) of the portable device 100) to the target device 200. Then, the target device 200 compares the identification information of the received signal with a pre-stored synchronization device list to determine whether or not the current portable terminal 100 is a device set to be synchronized with.

Based on the determination result, if the portable terminal 100 is determined as a device that is set for synchronization, a signal for initiating/requesting synchronization may be transmitted from the target device 200 to the portable terminal 100, and the portable terminal 100 receives the signal to initiate synchronization, which will be described below.

On the other hand, based on the determination result, if the portable terminal 100 is not determined to be a device that is set for synchronization, the target device 200 does not transmit a reply signal, or transmits a signal that the target device 200 is not for synchronization, in order to not perform synchronization processes with the current portable terminal 100.

According to the embodiment, the portable terminal 100 (receiving a signal that the target device 200 is not for synchronization) displays a message notifying that synchronization cannot be performed. Therefore, the user can be informed of a corresponding fact.

Once the network is established (e.g., communication channel is established/activated between the portable terminal 100 and the target device 200), information on the file type of the contents file to be synchronized is inputted in operation S22. For example, the user may directly input a specific file type of the contents file to be synchronized.

For instance, a user, who confirms that synchronization of a contents file is possible after the network is established, may directly select a specific contents file to be synchronized/updated or may directly input a file extension of a specific contents file to be synchronized/updated, such that the portable terminal 100 or the target device 200 may recognize the file type of the specific contents file, for example, an MP3 file or an image file. In another example, a controller in the device (e.g., 100 or 200) can check the file type information (e.g., file extension, etc.) to determine the file type of the contents file involved in the synchronization.

According to an embodiment, the portable terminal 100 or the target device 200 automatically identifies the file type of the corresponding contents file by recognizing a file to be synchronized. For example, a file extension of a corresponding file can be recognized by distinguishing a contents file stored in a folder that is designated for synchronization or all contents files stored in a memory, in the portable terminal 100. In another example, if a folder for storing music files in the portable terminal 100 is designated to be synchronized, then the contents files that will be involved in the synchronization will all be music files.

As discussed above, a synchronization method corresponding to the inputted file type is selected in operation S23. For instance, one of a plurality of different synchronization methods is selected based the file type of the contents file to be synchronized.

In one example, if the inputted file type (or determined file type) is a binary file such as an MP3 file or an image file, a file information comparison method that will be described later may be selected and used as a synchronization method. On the other hand, if the inputted/determined file type is a text file such as a phone book or a calendar, a change log comparison method that will be described layer may be selected and used as a synchronization method. However, the comparison method is not limited to the above, and may be configured variously.

Once the synchronization method is selected, the corresponding contents file is synchronized by using the selected synchronization method in operation S24.

Hereinafter, a change log comparing method and a file information utilizing method according to the present invention will be described as two different examples of the synchronization method of a contents file.

FIG. 2 is a block diagram illustrating examples of the portable terminal 100 and the target device 200 according to an embodiment.

The portable terminal 100 includes a radio communication unit 120, a memory unit 130, and a control unit 110. The portable terminal 100 may include other components which may be known, e.g., a wireless communication unit, a display unit, a network interface, an input unit, an output unit, etc. All components of the portable terminal 100 are operatively coupled.

The radio communication unit 120 transmits/receives a contents file to/from the target device 200 through a radio communication or other communication channels. The memory unit 130 stores various contents files and other data and information. The control unit 110 determines whether to transmit the contents file or not, and controls the transmitting/receiving of the contents file through the radio communication unit 120.

The target device 200 includes a radio communication unit 220, a memory unit 230, a control unit 210, and a display unit 240. The target device 200 may include other components which may be known, e.g., a wireless communication unit, an input unit, an output unit, a network interface, etc. All the components of the target device 200 are operatively coupled.

The radio communication unit 220 transmits/receives a contents file to/from the portable device 100 through a radio communication or other communication channels. The memory unit 230 stores various contents files and other data and information. The control unit 210 determines whether to transmit the contents file or not and controls the transmitting/receiving of the contents file through the radio communication unit 220. The display unit 240 displays one or more contents files stored in the memory unit 230 or files received from the portable terminal 100.

Each of the radio communication units 120 and 220 includes a receiving element for receiving a contents file and other data from other electronic devices, and a transmitting element for transmitting a contents file and other data to other electronic devices.

According to an embodiment, each of the memory units 130 and 230 can include one or more data memories for storing various contents files and one or more change log memories for storing change logs of the contents file.

The portable terminal 100 and the target device 200 can record therein and keep track of all file histories and changes associated thereto, and thus always can recognize a list of picture files, drawing files, or music files that they own currently. Changed items of the contents file can be recorded and stored in the change log memories of the portable terminal 100 and the target device 200.

The change log can include all items regarding adding, erasing, and/or modifying of contents files stored in each of the portable terminal 100 and the target device 200. Therefore, by analyzing and comparing the logs, items that may be added, erased, or modified for a particular contents file may be recognized and thus a synchronization process can be performed according to the embodiment.

According to an embodiment, the synchronization process may be performed using an automatic synchronization engine based on a Bluetooth object exchange (OBEX) protocol. The OBEX is a protocol set that allows objects such as contact address information or schedule information to be easily exchanged. In the present invention, the OBEX protocol is applied to transmitting the contents file in order to perform synchronization.

If the contents file is changed in the portable terminal 100 or the target device 200, the change occurrence history is recoded in the change log.

For example, if a new drawing or picture files are stored in the portable terminal 100, the fact that the new contents file is added is recorded in the change log. Additionally, if the originally stored file is deleted by a user's request, the fact that the contents file is deleted is recorded in the change log.

Similarly, if a new contents file is uploaded into the target device 200, the fact that the contents file is added is recorded in the change log of the target device 200.

Next, in an embodiment, the change logs of the portable terminal 100 and the target device 200 are compared to each other periodically at predetermined time intervals. Based on the comparison result, if there exists a contents file change and it is a new contents file, a request for transmitting the new contents file is issued to a corresponding device. For instance, a target device or a reference device can issue such a request to the other device.

If it is based on the OBEX protocol, the transmission of a corresponding contents file is requested through an OBEX GET request, and the corresponding contents file is transmitted from the requested side in response to the OBEX GET request about a specific contents file.

As mentioned above, the change log is compared periodically or at predetermined time intervals or at certain events, and the comparison process of the change log can be performed each time the contents file is changed according to the embodiment.

Based on the comparison result of the change log, if there is a change item in the portable terminal 100, the target device 200 can request the portable terminal 100 to transmit the corresponding contents file so that the corresponding contents file can be stored in the portable terminal 100, which in effect may constitute the contents file synchronization of the two devices. On the contrary, based on the comparison result of the change log, if there is a change item in the target device 200, the portable terminal 100 requests the target device 200 to transmit the corresponding contents file. The log of the portable terminal 100 may be compared with the log of the target device 200, either in the portable terminal 100 or the target device 200. And based on this comparison result, the portable terminal 100 or the target device 200 (functioning as a synchronization requesting device) can request for a synchronization as needed.

Once the requested contents file or part thereof (if only part is needed for synchronization) is transmitted to the applicable device (device 100 or 200) completely to update/synchronize the contents file in the corresponding device, the completing of the transmission is recorded in the change log (of the device 100 and/or 200 as applicable) in order not to re-transmit the same file during the next comparison.

Additionally, a contents file of the portable terminal 100 may be deleted sometimes according to an embodiment. In this case, the fact about the deletion of the contents file is recorded in the change log of the portable terminal 100, and the target device 200 which is notified of the fact about the deletion of the contents file may be configured not to delete the corresponding contents file stored in the target device 200. On the contrary, the file deleted in the target device 200 may be configured to be also deleted in the portable terminal 100. That is, the devices 100 and 200 can be configured such that the file contents synchronization may occur selectively or only upon an occurrence of certain events, e.g., addition or modification of contents files.

According to another embodiment, a picture file or a drawing file may be configured to be transferred only from the portable terminal 100 to the target device 200, and a music file (for example, an MP3 file) may be configured to be transferred only from the target device 200 to the portable terminal 100.

As discussed above, the contents file synchronization according to the present invention can be performed between the portable terminal 100 and the target device 200 via the Bluetooth OBEX protocol based automatic synchronization engine, but the present is not limited thereto. For example, the synchronization may be performed by a Bluetooth serial port profile (SPP) based automatic synchronization engine.

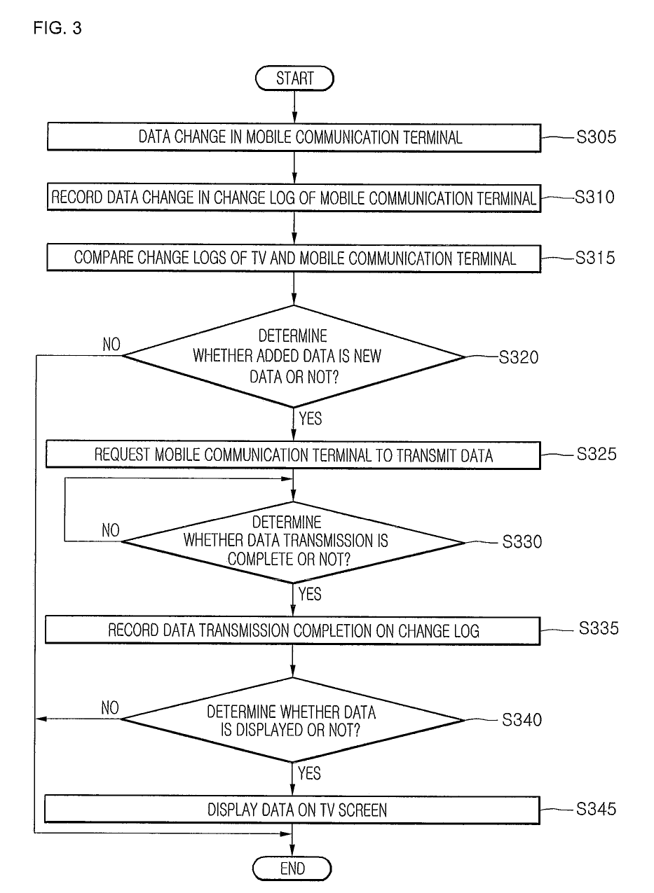

FIG. 3 is a flowchart illustrating a contents file synchronization process when a contents file is changed in a portable terminal according to an embodiment. This method can be implemented in a system having the devices 100 and 200, or in other suitable systems having two electronic devices capable of communicating with each other.

When a user of the portable terminal (e.g., device 100) receives a contents file from another portable terminal or a server, or a new picture file is generated using a camera function embedded in the portable terminal, the contents file of the user's portable terminal is changed in operation S305. This change item is recorded in the change log memory in a memory unit of the portable terminal in operation S310.

Next, change logs of a target device (e.g., device 200) and the portable terminal are compared with each other in operation S315. As mentioned above, the comparison of the change logs between the two devices may be periodically performed at a predetermined time interval, or each time the contents file is changed, the comparison may be performed. The comparison of the change logs can occur in the portable terminal or the target device. In this example, it is assumed that the target device obtains the change log of the portable terminal from the portable terminal, and compares it with the change log of the target device.

Next, it is determined whether the changed contents file is a new contents file or not in operation S320. For instance, the target device can determine if the change indicated by the above comparison result is due to the addition of a new contents file in the portable terminal. One reason for this operation is to address a situation where the contents file, which is previously backed-up and stored in a storage device of the target device, may be received in the portable terminal again. Based on the determination result at operation S320, if the added contents file is not a new contents file, then it would be determined that the backup is not required since the change item in the portable terminal is already stored in the target device. As a result, the synchronization process ends here and is thereby completed.

However, based on the determination result at operation S320, if the added contents file is a new contents file that does not previously exist, the target device requests the portable terminal to transmit the contents file (or part hereof) in operation S325. Next, it is determined (e.g., by the target device) whether the contents file is transmitted completely or not in operation S330. Once the contents file transmission is completed, the fact about the completion of the contents file transmission is recorded in the change log of the target device (and maybe also in the portable terminal) in operation S335. This process is to prevent the same contents file transmission again.

Next, if the changed contents file in the portable terminal is a picture or drawing file, a user at the target device can determine whether to display the received picture or drawing file on a display (e.g., display unit 240) of the target device that received the changed contents file from the portable terminal in operation S340.

Based on the determination result at operation S340, if the user wants the received picture or drawing file to be displayed, it is displayed on a screen of the display in the target device in operation S345. If not, the changed contents file is stored in a contents file memory of the memory unit in the target device and is not displayed on the screen of the target device.

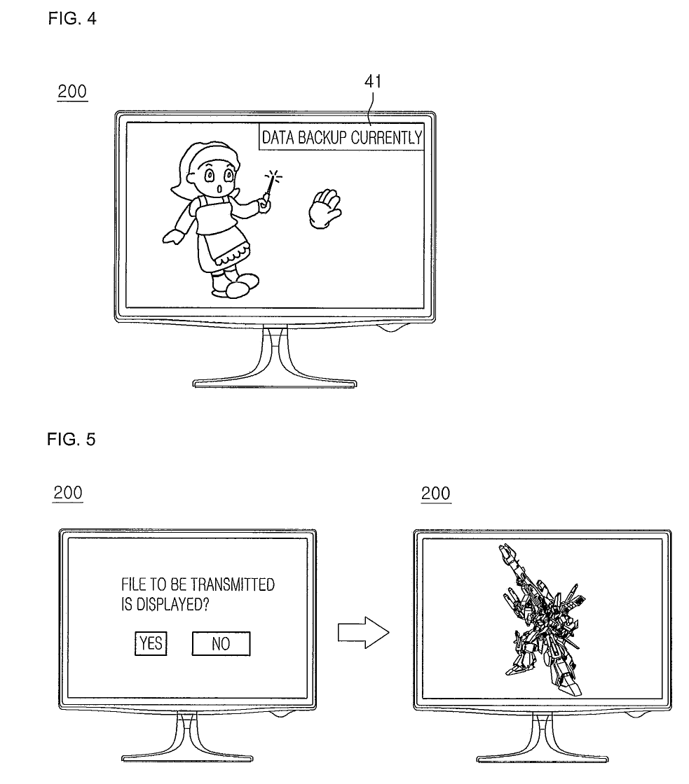

Various embodiments about methods of displaying a picture or drawing file (contents file received by the target device) on the screen of the target device may be provided. This will be described in more detail with reference to FIGS. 4 and 5.

FIGS. 4 and 5 are views displaying an example of a contents file (e.g., picture or drawing file) on a screen of a target device when the contents file is transmitted to the target device according to the embodiment of FIG. 3.

As illustrated in one example of FIG. 4, when the target device receives a contents file, a predetermined mark or indication 41 notifying about the transmission of the contents file may be displayed on the screen of the target device. The mark 41 may be displayed in a small size at the edge area of the screen transparently or semi-transparently in order not to overlap the screen area that the user currently is viewing.

In the example of FIG. 4, the text “DATA BACKUP CURRENTLY” is displayed as an example of the mark 41, but the mark 41 can be a specific animation and/or a specific sound (an alarm). In fact, the mark or indication 41 can be of any form, size, format, image, symbol, character, sound, any combination thereof, etc.

Once the contents file is transmitted completely, as illustrated in FIG. 5, the target device may ask the user whether or not the user wants the received contents file to be displayed on the screen of the target device, and the user may enter the user's preference via the input unit of the target device. Also, the target device may ask the user whether or not the user wants the contents file to be transmitted to be displayed on the screen of the target device, and the user may enter the user's preference via the input unit of the target device. In a case where the user wants continuously watch programs or videos, the picture or drawing file that is received from the terminal 100 (or to be transmitted to the terminal 100) can be displayed on the screen only if the user wants it to be displayed through the above confirmation process.

As a variation, according to an embodiment, once the corresponding picture or drawing file (contents file) is received completely, the received contents file may be configured to be displayed on the screen of the target device immediately and automatically.

As another variation, according to an embodiment, the received files may be configured to be displayed sequentially like a slide show.

As another variation, according to an embodiment, if the screen of the target device is not activated, the picture or drawing file is automatically backed-up in the memory unit of the target device, and when the screen is activated again, it may be configured to confirm a user's preference on whether or not the received file should be displayed on the screen of the target device, or to display it automatically on the screen.

Additionally, although the received file may be displayed on the entire screen of the target device in FIG. 5, the picture or drawing file may be partially displayed in a picture in picture (PIP) method or a picture out picture (POP) method.

According to an embodiment, if the display of the target device 200 is turned off, a message or a pop-up window notifying that the synchronization is completed may be displayed, when the display is turned on again. Other variations are possible.

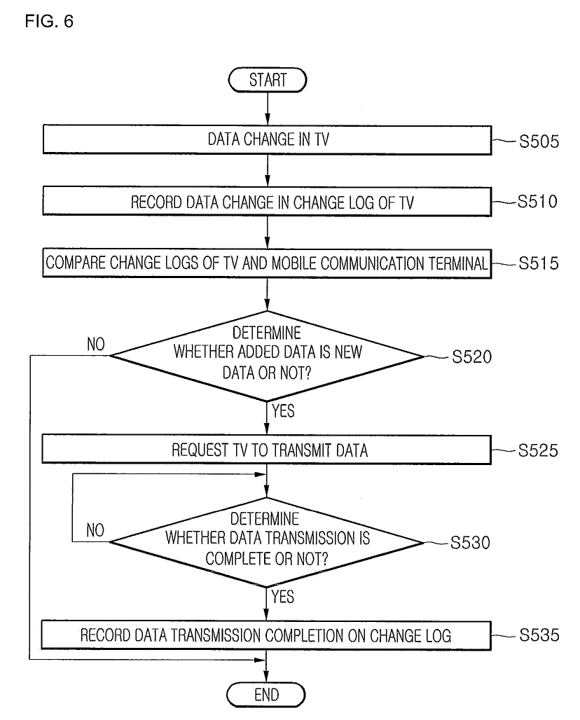

FIG. 6 is a flowchart illustrating a contents file synchronization process when a contents file is changed in a target device (e.g., TV, PC, etc.) according to an embodiment.

In operation S505, when a user of the target device receives a contents file from another portable terminal, a broadcasting station or a server, a contents file of the target device is changed. This change item is recorded in a change log memory in a memory unit of the target device in operation S510.

Next, the change logs of the target device and the portable terminal are compared with each other in operation S515. This comparison can preferably occur in the target device, but can occur in the portable terminal. As mentioned above, the comparison of the change logs between the two devices may be periodically performed at a predetermined time interval, or each time the contents file is changed, the comparison may be performed.

Next, it is determined (e.g., by the target device or the portable device) whether the changed contents file is a new contents file or not in operation S520. This operation is useful to address a scenario where the contents file that is previously downloaded and stored in the memory of the portable terminal may be received in the target device again. Based on the determination result at operation S520, if the added contents file is determined not to be a new contents file, the download is not required. As a result, the synchronization process ends here and is thereby completed.

However, based on the determination result at operation S520, if the added contents file is determined to be a new contents file that did not exist previously in the portable terminal, the portable terminal requests the target device to transmit the contents file to the portable terminal in operation S525. Next, it is determined whether the contents file is transmitted completely or not in operation S530, once the transmission of the contents file is completed, the fact about the completion of the contents file transmission is recorded in the change log of the portable terminal (and maybe also in the target device) in operation S535. This process is to prevent the same contents file transmission again.

In the above embodiments, a method and system for synchronizing a contents file by transmitting and receiving the contents file between the portable terminal and the target device are discussed. However, the present invention may be configured to perform synchronization of a contents file between portable terminals. For example, the system may be configured to synchronize contents files stored in portable terminals that family members use.

According to an embodiment, it may be configured to transmit contents files simultaneously between a plurality of portable terminals. For example, it may be configured that each portable terminal among a plurality of portable terminals is identified and a storage space corresponding to each portable terminal is distributed to back-up a contents file.

According to an embodiment, the synchronization method may be applied between the portable terminal and the personal computer.

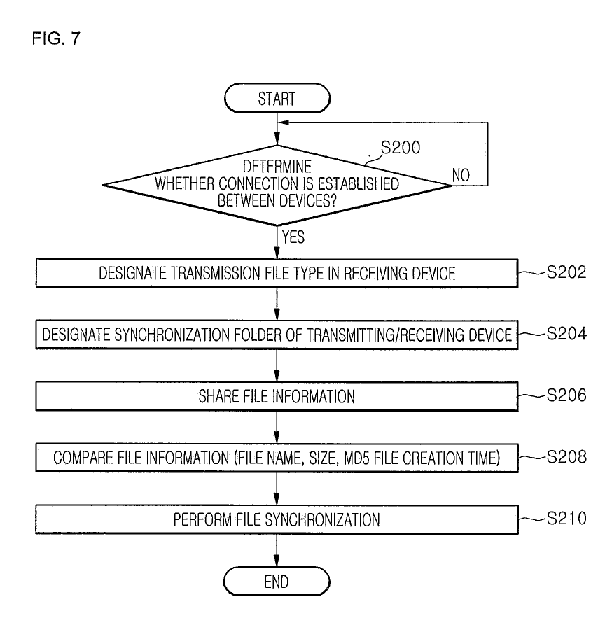

FIG. 7 is a flowchart illustrating a synchronization process using file information according to another embodiment.

For example, in order to transmit a contents file (such as picture, video, and music files) stored in the portable terminal 100 to the target device 200, an attempt to establish a connection between the portable terminal 100 and the target device 200 is made through network connection techniques such as USB or Bluetooth equipped in the portable terminal 100 and the target device 200.

According to an embodiment, when the portable terminal 100 approaches the target device 200 and the two devices 100 and 200 are placed within a predetermined distance, the contents file synchronization of the present invention may be performed automatically, or a message for notifying that such synchronization is possible may be provided to user(s) of the device(s) 100 and 200. In the latter case, the user may select whether to synchronize a contents file or not. If the user wants the contents file synchronization, the contents file may be synchronized according to a synchronization method that will be described later.

Once the connection between the portable terminal 100 and the target device 200 is confirmed in operation S200, the file type of the contents file to be synchronized is designated in operation S202. This is for designating one of a plurality of file formats such as video, picture, and music files, in order to perform synchronization. In an example, the target device or user in the target device (or the reference device or the user in the reference device) may decide that only music files may be synchronized.

According to the embodiment, the portable terminal 100 may apply respectively different synchronization methods according to various file types of file contents involved in synchronization. For example, it may be configured that the synchronization method of FIG. 7 is applied in a case of a picture file, while the synchronization method of FIG. 3 is applied in a case of a music file. The setting of the above synchronization method may be configured by a user or a manufacturer of the portable terminal 100. Configuring which synchronization method may be used for which file type may be done by a user, device (100 or 200), or may be preset. Such configurations may be modifiable by the user or administrator as needed.

According to an embodiment, in order to perform the contents file synchronization between the portable terminal 100 and the target device 200, a folder to be synchronized in the portable terminal 100 or the target device 200 is selected among multiple folders in operation S204. In the present invention, it is described that a folder unit is designated for synchronization, but all files in the portable terminal 100 and the target device 200 may be synchronized. For instance, the target device or the user of the target device (or the reference device or the user of the reference device) may decide that only a particular folder containing certain contents files may be involved in the synchronization.

According to the one embodiment, the step of designating the file type S202 and the step of selecting the folder S204 may be performed prior to the step of connecting the devices S200.

According to an embodiment, when a plurality of different users use the same portable terminal 100 or the same target device 100, the designating of the folder to be synchronized may be different according to each user.

For example, once a user A designates a folder ‘a’ in the target device 200 for the synchronization, and then if another user such as a user B desires to designate a folder in the target device 200 for synchronization, it is possible for the user B to designate a folder except for the folder ‘a’ that the user A designates or it is possible for the user B to create a new folder for synchronization. For synchronization, different users can designate different folders for each user's synchronization.

Once the folder to be synchronized is designated at operation S204, the target device 200 receives file information of a reference contents file stored in a folder (corresponding to the designated folder) from the portable terminal 100 in operation S206. At this point, the received file information includes at least two of the following: a file name, a file size, a hash value, and a file creation time of a reference contents file. According to an embodiment, the file information of the reference contents file can further include a change log of the reference contents file. File information of a target contents file would also have the same information pertaining to the target contents file.

Here, the hash value is an output value obtained by applying a hash algorithm or a hash function to the reference contents file. According to the embodiment, the hash value may be an MDS output value or a SHA output value that an MD5 or SHA algorithm is applied as a hash algorithm.

Additionally, the file creation time may include at least one of creation year, month, day, time, minute, and second.

The target device 200 compares the received file information of the reference contents file in the folder received from the portable device 100 with the file information of a target contents file in the designated folder in operation S208.

At this point, it is determined (e.g., by the target device 200) which reference contents file or part thereof in the portable terminal 100 needs to be transmitted to the target device 200, so that the target reference file in the designated folder of the target device can be updated based on the reference contents file and thereby be synchronized to the reference contents file. In addition, it may be determined (e.g., by the target device 200) which file (or part thereof) in the target device is to be received by the portable terminal 100, if some files of the portable terminal 100 may need to be updated based on the files of the target device 200.

As mentioned above, once files to be transmitted and files to be received are determined, synchronization is performed in operation S210. That is, the contents file synchronization may include one of the following: (a) updating the files of the device 100 using the files of the device 200, (a) updating the files of the device 200 using the files of the device 100, or (b) performing both (a) and (b) at the same time or in some designated order.

According to one embodiment, the portable device 100 and/or the target device 200 may display on its own screen a pop-up window for indicating the completion of the above synchronization.

In addition, the portable device 100 (if functioning as a reference device) may further display a pop-up window for asking its user whether or not to delete the reference contents file already transmitted to the target device for synchronization. As a result, the portable device 100 can be configured to delete the reference contents file which is already backed-up in the memory unit of the target device, so that the memory unit of the portable device 100 is not used up by storing undesirable files.

In addition, the target device 200 may further display on its screen a pop-up window for asking whether or not to delete the reference contents file that is received from the portable terminal for synchronization, so that user can manage the files in the portable device 100 using the target device 200.

In this case, if the user of the target device chooses the deletion of the received reference contents file (since the target contents file has been synchronized), the target device 200 may transmit a command signal to the portable device 100 to delete the corresponding reference contents file from the portable device 100.

According to one embodiment, the pop-up window asking whether or not to delete the reference contents file may not be displayed right after the synchronization, but in case of the depletion of the memory space of the portable device 100 or the target device 200.

For example, when the portable device 100 runs short of memory space, the portable device 100 may display on its screen a pop-up window such as “Do you want to delete contents files already synchronized?” to confirm whether or not to delete the reference contents file which is already backed-up in the target device 200.

For this purpose, the portable device 100 can store information indicating which contents file is synchronized among the reference contents files stored in the portable device 100.

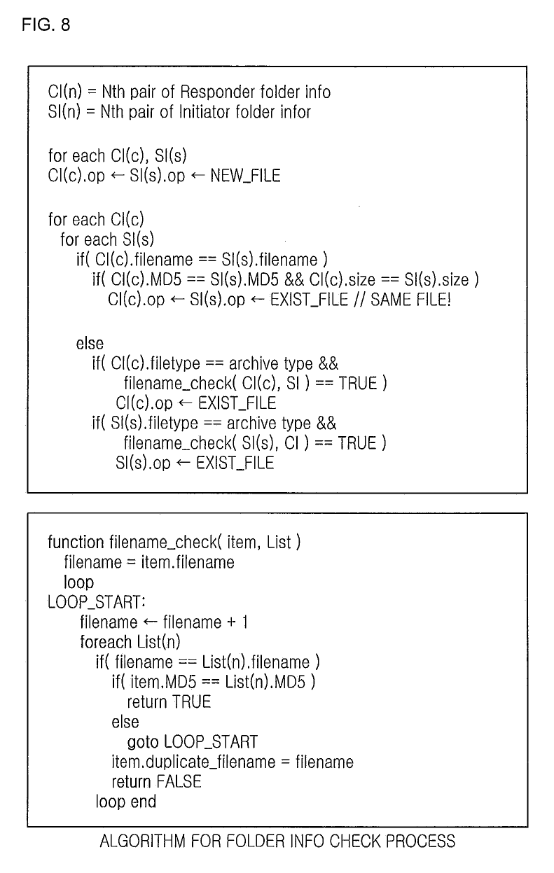

FIG. 8 is a view illustrating an example of an algorithm that confirms file information of a contents file in a folder according to an embodiment.

Referring to FIG. 8, the target device 200 includes an algorithm for implementing a method of identifying and comparing a file to be received, a file to be transmitted, and a file unnecessary for transmission through the file information received from the portable device 100.

In relation to the above comparison as shown in FIG. 8, while comparing a pair of files, it is determined whether an identical file exists or not. For example, the file names of the files are compared first. It is determined that the files are different from each other if their names (file names) are different from each other.

On the other hand, if their names are the same, then their hash values are compared. If the hash values are the same, then this means the two files have the same contents. Thus, it is determined that the files are the same, even if they have the different file names.

According to an embodiment, if the file size is compared and its comparison result is the same before comparing a hash value, the hash value can be compared. According to the embodiment, if the file names are the same and the files have the different sizes, it may be defined that the two files are different.

If the hash values of the two files are different, the two files may be determined to be different so that one file needs to be transmitted to the other side for file synchronization.

According to an embodiment, if the hash values of the files are the same, the creation time (or file generation time) of the file may be additionally compared, but comparing the file creation times is not limited to being performed after comparing the hash values. That is, the comparison of the file creation time may be performed before comparing the hash values, comparing the file names, or comparing the file sizes.

According to an embodiment, a contents file that is defined as different one and will be transmitted may change its file name. That is, a new file name may be designated to that contents file.

If, according to an embodiment, the newly designated file name is compared again with the file names of target contents files stored in the target device 200 such that the use of duplicate file name can be prevented.

The algorithm for contents file synchronization including comparison of file information according to an embodiment of the present invention is summarized as follows:

If a file name (name of file) of a specific file is different from a file name of another file, then the specific file is different;

If the file names are the same, hash values of the files are compared;

If the hash values are the same, two files are determined to be the same;

If the hash values are different, archive type/download;

Duplicate check according to a type setting.

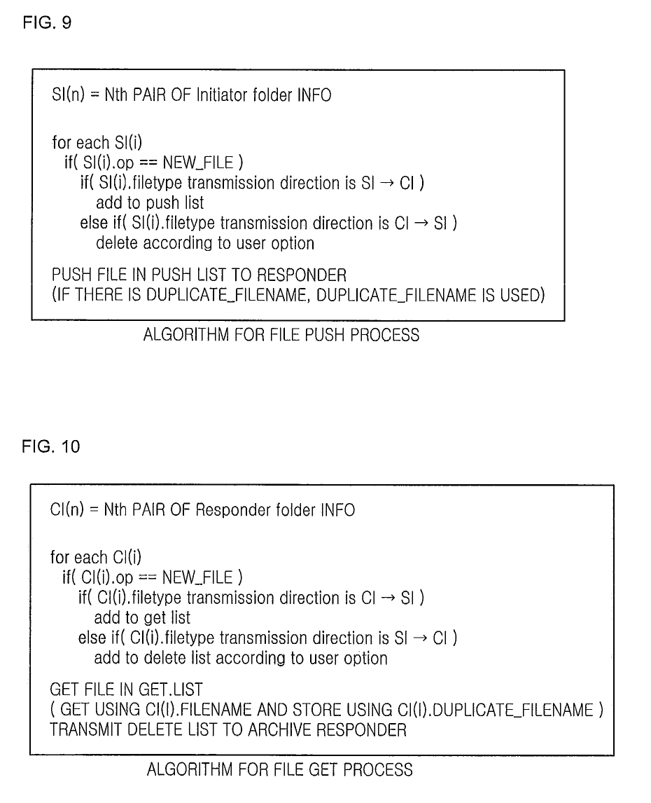

FIG. 9 is an example of an algorithm for detecting a file to be transmitted and transmitting a file according to an embodiment.

FIG. 9 illustrates an example of an algorithm using file information in order to transmit the determined one of a file to be transmitted, a file to be received, and a file to be deleted, from the portable terminal 100 to the target device 200. FIG. 10 illustrates an example of an algorithm for determining the receiving of a file and the deleting of a file of a target device according to an embodiment.

In this operation, it is tested whether there is a file to be deleted or not, except for files to be transmitted. This condition is determined based on which direction a file type is transmitted.

For example, under the assumption that a picture file is transmitted from the portable terminal 100 to the target device 200, if there is a file only existing in the target device 200 and not in the portable terminal 100, the file is not transmitted from the target device 200 to the portable terminal 100. Additionally, the file in the target device 200 is deleted.

According to an embodiment, a function for deleting a target contents file in the target device 200 may be enabled or disabled by a user.

Additionally, according to an embodiment, this deletion function may be enabled or disabled according to the file type of the contents file. For example, a user may not delete a relatively small image file and may continuously store it in the target device. Also, the user may enable the deletion function for a relatively large video file. As a result, the storage capacity of the memory can be managed efficiently.

The deletion function based on the above file type may be configured by a user or by a manufacturer at the manufacturing of a device.

The various algorithms of FIGS. 8-10 are mere examples, which can be used in the methods of the present invention.

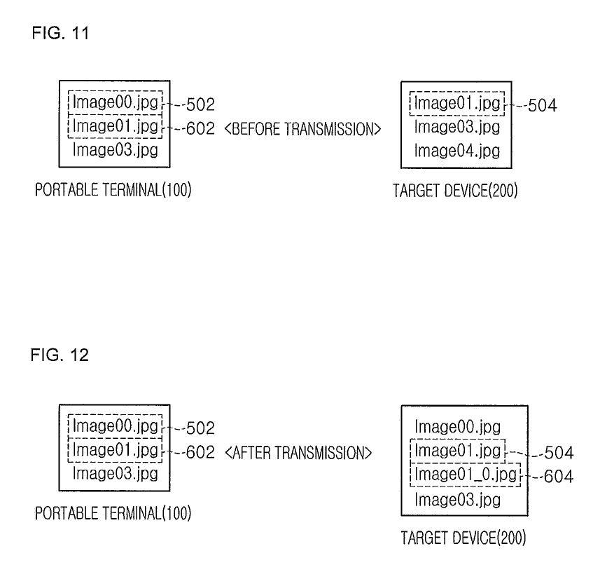

FIGS. 11 and 12 are views illustrating a process and a process result when a picture in a mobile phone is transmitted to a target device according to an embodiment.

More specifically, FIGS. 11 and 12 illustrate an example about a process and a process result when a picture stored in the portable terminal 100 is transmitted to the target device 200 through the above-suggested algorithms. As shown in the result after the transmission of the picture file, if the file information is utilized, file contents in one side are identically applied to the other side even if all files are not transferred.

In more detail, in FIG. 11, it is assumed that the portable terminal 100 includes three pictures, e.g., image00.jpg 502, image01.jpg 602 and image03.jpg, and the target device 200 includes image01.jpg 504, image03.jpg, and image04.jpg.

Here, image01.jpg 504 in the target device 200 has the same filename as image01.jpg 602, but has different contents from image01.jpg 602.

If the above mentioned algorithms are applied to the contents file for synchronization, one example of the result is shown FIG. 12.

First, image00.jpg 502 in the portable terminal 100 is transmitted to the target device 200 because image01.jpg 504 has a different name. Further, there is no file name in the target device 200 (as shown in FIG. 11) that matches image00.jpg.

Second, the file name of image00.jpg 602 in the portable terminal 100 is identical to that of image01.jpg 504 of the target device 200, but even if the file names are the same, their hash values are compared to determine whether they are identical or not. Since the two files have the same name but their contents are different from each other and thus the hash values are different from each other, image01.jpg 602 in the portable terminal 100 is changed into image01_{—}0.jpg 604 (new file name) and then transmitted to the target terminal 200.

Further, since image03.jpg of the portable terminal 100 is already in the target device 200, it is not transmitted from the portable terminal 100 to the target device 200.

Moreover, since image04.jpg in the target device 200 is not in the portable terminal 100 and only in the target device 200, this file may be deleted from the target device 200. However, according to an option, image04.jpg may be continuously stored in the target device 200 or may be transferred to the portable terminal 100.

As mentioned above, when a reference contents file of the portable terminal 100 and a target contents file of the target device 200 are synchronized, once the portable terminal 100 and the target device 200 are connected, one folder may be selected for synchronization and the file information of that folder of a device to be transmitted is received. Then, through the comparison of the file information, a file to be transmitted, a file to be received, and/or a file to be deleted is determined to perform the file contents synchronization according to the present invention. As a result, through a simple algorithm, the file synchronization can be performed without difficulties.

As discussed above, the file contents synchronization methods according to the embodiments are applied to a synchronization device (e.g., the portable terminal in the above description) in order for performing the synchronization process. However, also as discussed above the present invention is not limited thereto. That is, the synchronization methods of the present invention may be equally applied to the target device 200 so that the target device 200 can perform the contents file synchronization process on the portable terminal 100 through the above-mentioned synchronization methods.

According to the present invention, in order to synchronize a contents file between two electronic devices, a relatively small amount of file information, e.g., a file name, a file size, a hash value, and/or file creation time, is transmitted and compared to determine whether a contents file is identical or not. Therefore, time for synchronization can be reduced.

Additionally, according to an embodiment, only one file information is not compared, but at least two among a plurality of file information are compared to determine whether two files are identical or not. As a result, synchronization reliability can be improved.

Moreover, the type of file information, the number of files, and a comparison order of file information, which are compared if necessary, may be adjusted. Therefore, synchronization time and reliability can be balanced in order to meet the usage environment of a user.

Until now, the present invention is examined based on preferred embodiments, and those skilled in the art may realize different forms of embodiments different from the detailed descriptions of the embodiments of the present invention. Here, it should be understood that all differences within the equivalent scope of the claims are included in the present invention.

Any reference in this specification to “one embodiment,” “an embodiment,” “example embodiment,” etc., means that a particular feature, structure, or characteristic described in connection with the embodiment is included in at least one embodiment of the invention. The appearances of such phrases in various places in the specification are not necessarily all referring to the same embodiment. Further, when a particular feature, structure, or characteristic is described in connection with any embodiment, it is submitted that it is within the purview of one skilled in the art to effect such feature, structure, or characteristic in connection with other ones of the embodiments.

Although embodiments have been described with reference to a number of illustrative embodiments thereof, it should be understood that numerous other modifications and embodiments can be devised by those skilled in the art that will fall within the spirit and scope of the principles of this disclosure. More particularly, various variations and modifications are possible in the component parts and/or arrangements of the subject combination arrangement within the scope of the disclosure, the drawings and the appended claims. In addition to variations and modifications in the component parts and/or arrangements, alternative uses may also be apparent to those skilled in the art.

What is claimed is:

1. A method for synchronizing data using a target device, the target device including a target contents file, the method comprising:
receiving file information of a reference contents file from a reference device;
comparing the file information of the reference contents file and file information of the target contents file to determine whether a contents file synchronization is needed; and
synchronizing the target contents file using the reference contents file based on the comparison result.

2. The method of claim 1, wherein the file information comprises at least two of the following: a file name, a file size, a file creation time, and a hash value of a file.

3. The method of claim 2, wherein the comparing step comprises:
first comparing a file name of the reference contents file with a file name of the target contents file;
second comparing a hash value of the reference contents file with a hash value of the target content file, if the first comparing step indicates that the file names are identical; and
determining that the reference contents file and the target contents file are different, if the second comparing step indicates that the hash values are not identical.

4. The method of claim 3, after the first comparing of the file names, the method further comprises determining that the reference contents file and the target contents file are different if the first comparing step indicates that the file names are not identical.

5. The method of claim 3, after the second comparing of the hash values, the method further comprises determining that the reference contents file and the target contents file are identical if the second comparing step indicates that the hash values are identical.

6. The method of claim 3, after the first comparing of the file names, the method further comprises:
third comparing a file size of the reference contents file with a file size of the target contents file, if the first comparing step indicates that the file names are identical; and
fourth comparing the hash values of the reference contents file and the target contents file, if the third comparing step indicates that the file sizes are identical.

7. The method of claim 1, before the receiving step, the method further comprises:
designating at least one of a file type and a target folder to be synchronized.

8. The method of claim 1, wherein the target device is a non-mobile device, and the reference device is a mobile device.

9. The method of claim 1, wherein the target device is a mobile device, and the reference device is a non-mobile device.

10. A method for synchronizing data using a synchronization requesting device, the method comprising:
determining, by the synchronization requesting device, file type information of a target contents file which is to be synchronized;
selecting a synchronization method corresponding to the determined file type information; and
selectively synchronizing the target contents file with a reference contents file according to the selected synchronization method.

11. The method of claim 10, wherein the selectively synchronizing step includes:
comparing file information of the reference contents file with file information of the target contents file, wherein the file information comprises at least two of the following: a file name, a file size, a file creation time, and a hash value of a file; and
synchronizing the target contents file using the reference contents file based on this comparison result.

12. The method of claim 10, wherein the selectively synchronizing step includes:
first comparing a file name of the reference contents file with a file name of the target contents file;
second comparing a hash value of the reference contents file with a hash value of the target content file, if the first comparing step indicates that the file names are identical;
determining that the reference contents file and the target contents file are different, if the second comparing step indicates that the hash values are not identical; and
synchronizing the target contents file using the reference contents file based on this determination result.

13. A target device for synchronizing data with a reference device, the target device comprising:
a storage unit configured to store therein a target contents file;
a communication unit configured to communicate with the reference device; and
a controller configured to receive file information of a reference contents file from the reference device, through the communication unit; to compare the file information of the reference contents file and file information of the target contents file to determine whether a contents file synchronization is needed; and to synchronize the target contents file using the reference contents file based on the comparison result.

14. The target device of claim 13, wherein the file information comprises at least two of the following: a file name, a file size, a file creation time, and a hash value of a file.

15. The target device of claim 14, wherein the controller is configured to compare the file information of the reference contents file and the file information of the target contents file by:
first comparing a file name of the reference contents file with a file name of the target contents file;
second comparing a hash value of the reference contents file with a hash value of the target content file, if the first comparing step indicates that the file names are identical; and
determining that the reference contents file and the target contents file are different, if the second comparing step indicates that the hash values are not identical.

16. The target device of claim 15, after the first comparing of the file names, the controller is further configured to perform the following steps:
third comparing a file size of the reference contents file with a file size of the target contents file, if the first comparing step indicates that the file names are identical; and
fourth comparing the hash values of the reference contents file and the target contents file, if the third comparing step indicates that the file sizes are identical.

17. The target device of claim 13, wherein the target device is a non-mobile device, and the reference device is a mobile device.

18. The target device of claim 13, wherein the target device is a mobile device, and the reference device is a non-mobile device.

19. A synchronization requesting device for synchronizing data with a reference device, the synchronization requesting device comprising:
a storage unit configured to store therein a target contents file;
a communication unit configured to communicate with the reference device; and
a controller configured to determine file type information of the target contents file which is to be synchronized; to select a synchronization method corresponding to the determined file type information; and to selectively synchronize the target contents file with a reference contents file through the communication unit according to the selected synchronization method.

20. The synchronization requesting device of claim 19, wherein the controller is configured to:
compare file information of the reference contents file with file information of the target contents file, wherein the file information comprises at least two of the following: a file name, a file size, a file creation time, and a hash value of a file; and
synchronize the target contents file using the reference contents file based on this comparison result.

21. The synchronization requesting device of claim 19, wherein the controller is configured to:
first compare a file name of the reference contents file with a file name of the target contents file;
second compare a hash value of the reference contents file with a hash value of the target content file, if the first comparing step indicates that the file names are identical;
determine that the reference contents file and the target contents file are different, if the second comparing step indicates that the hash values are not identical; and
synchronize the target contents file using the reference contents file based on this determination result.
